(19) United States
(12) Patent Application Publication
(10) Pub. No.: US 2006/0071478 A1
(43) Pub. Date: Apr. 6, 2006

(54) Multi-point sliding door

(75) Inventor: Andre Denys, Sterling Heights, MI (US)

Correspondence Address: WILLIAM M HANLON, JR;YOUNG & BASILE, PC, 3001 WEST BIG BEAVER ROAD, SUITE 624, TROY, MI, 48084-3107, US

(73) Assignee: FASCO DIE CAST INC., Mississauga (CA)

(21) Appl. No.: 10/957,969

(22) Filed: Oct. 4, 2004

(51) Int. Cl. E05C 19/10

(52) U.S. Cl. 292/26

(57) ABSTRACT

A multipoint sliding door latch including a housing, a pair of vertically spaced upper and lower hooks mounted in the housing for movement between a retracted, unlatched position within the housing and an extended, latched position extending out of the housing for engagement with a keeper structure of an associated jamb, upper and lower rotary actuators mounted in the housing in vertically spaced side by side relation between the upper and lower hooks, an upper link mechanism interconnecting the upper actuator and the upper hook and operative in response to rotary movement of the upper actuator to move the upper link from an unlatched to a latched position, and a lower link mechanism interconnecting the lower actuator and the lower hook and operative in response to rotary movement of lower actuator to move the lower hook from an unlatched position to a latched position. The latch further includes a rack positioned between the actuators and defining gear teeth on opposite parallel faces thereof. Each actuator includes pinion gear teeth and the pinion gear teeth of the upper actuator meshingly engage the gear teeth on one face of the rack and the pinion gear teeth on the lower actuator meshingly engage the gear teeth on the opposite face of the rack. The rack comprises a cylindrical member having a series of circumferential ribs defining the gear teeth and the cylindrical rack member is mounted in the housing for rotary movement about its central axis.

### BACKGROUND OF THE INVENTION

This invention relates to multi-point door latches and more particularly to a multi-point door latch especially suitable for use with sliding doors.

In a typical sliding patio door installation, the door is maintained in a latched and/or locked condition by a latch mounted in the lock face of the style of the sliding door and having a single hook or other latching element coacting with a keeper structure on the associated door jamb. Whereas these so called single point constructions are satisfactory for most installations, there is increasing need and demand for more security with respect to sliding patio doors to preclude forced entry. In an effort to increase the latch security, so-called multi-point latches have been developed and utilized in which more than one latching element engages the keeper structure of the jamb to provide a more secure latching arrangement and provide more security against forced entry. Whereas these multi-point latch structures do increase the strength of the latch and thereby guard against forced entry, they tend to be very complicated and expensive and they tend to be intolerant of manufacturing variations in the various components utilized to form the latch.

### SUMMARY

This invention is directed to the provision of an improved sliding door multi-point latch.

More specifically this invention is directed to the provision of a sliding door multi-point latch that is simple and inexpensive in construction and that is relatively tolerant of dimensional and configurational variations in the manufacture of the various components.

The invention relates to a multi-point sliding door latch including a housing, a pair of vertically spaced upper and lower hooks mounted in the housing for movement between a retracted, unlatched position within the housing and an extended, latched position extending out of the housing for engagement with a keeper structure of an associated jamb, upper and lower rotary actuators mounted in the housing in vertically spaced side by side relation between the upper and lower hooks, an upper link mechanism interconnecting the upper actuator and the upper hook and operative in response to rotary movement of the upper actuator to move the upper link from an unlatched to a latched position, and a lower link mechanism interconnecting the lower actuator and the lower hook and operative in response to rotary movement of the lower actuator to move the lower hook from an unlatched position to a latched position.

According to an important feature of the invention, the latch further includes a rack positioned between the actuators and defining gear teeth on opposite parallel faces thereof; each actuator includes pinion gear teeth; and the pinion gear teeth of the upper actuator meshingly engage the gear teeth on one face of the rack an the pinion gear teeth on the lower actuator meshingly engage the gear teeth on an opposite face of the rack.

According to a further feature of the invention, the rack comprises a cylindrical member having a series of circumferential ribs defining the gear teeth.

According to a further feature of the invention, the cylindrical rack member is mounted in the housing for rotary movement about its central axis.

According to a further feature of the invention, at least one of the link mechanisms comprises a mechanism that is operative in response to a turning force applied at the respective actuator to move the respective hook from its latched to its latched position but is operative in response to a force applied at the hook to block movement of the hook from its latched to its unlatched position.

According to a further feature of the invention, the one linkage mechanism includes at least one link and a post fixed to the housing; the one link includes a slot that receives the fixed post in response to movement of the respective hook from its unlatched to its latched position; and force applied to the hook in the latched position thereof generates a force urging the one link against the fixed post.

According to a further feature of the invention, the fixed post comprises a pivot pin in the linkage mechanism.

According to a further feature of the invention, the latch further includes a lock mechanism normally operative to preclude movement of the hooks from the unlatched to the latched position but operative in response to engagement thereof with the keeper structure of the associated jamb to allow such movement. In the disclosed embodiment of the invention, the lock mechanism comprises a lever pivotally mounted on the housing and including an actuator arm and a lock arm; the lock mechanism further includes a spring normally maintaining the lever in a position in which the actuator arm projects out of the housing and the lock arm blocks movement of the hooks from their unlatched to their latched positions; and the lever rotates against the bias of the spring in response to engagement of the actuator arm with the keeper structure of the associated jamb upon closing of the door against the jamb to rotate the lock arm to a position allowing movement of the hooks from their unlatched to their latched positions.

According to a further feature of the invention, each hook undergoes a combined translatory and rotational movement in its movement from an unlatched position to a latched position.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a somewhat schematic view looking from inside to outside of a typical sliding patio door installation;

FIG. 2 is a perspective view of a latch according to the invention;

FIG. 3 is an exploded fragmentary view of a sliding door assembly utilizing the invention latch;

FIG. 4 is a somewhat schematic cross-sectional view of the latch showing the hook members of the latch in an unlatched position;

FIG. 5 is a view similar to FIG. 4 but showing the hook members in the latched position;

FIG. 6 is an exploded perspective view of an actuator assembly utilized in the invention latch;

FIGS. 7 and 8 are fragmentary views of the actuator assembly showing unlatched and latched positions, respectively;

FIG. 9 is a cross-sectional view taken on line 9-9 of FIG. 7;

FIG. 10 is a fragmentary perspective view of a link mechanism utilized in the latch;

FIGS. 11, 12 and 13 are fragmentary progressive views showing the latching movement of a hook member;

FIGS. 14 and 15 are cross-sectional views taken respectively on lines 14-14 and 15-15 of FIG. 1;

FIG. 16 is a fragmentary perspective view of a further link mechanism utilized in the latch;

FIG. 17 is a fragmentary perspective view looking in the direction of the arrow 17 in FIG. 1; and

FIG. 18 is a fragmentary detail view showing the coaction of a hook member and a keeper structure.

### DETAILED DESCRIPTION

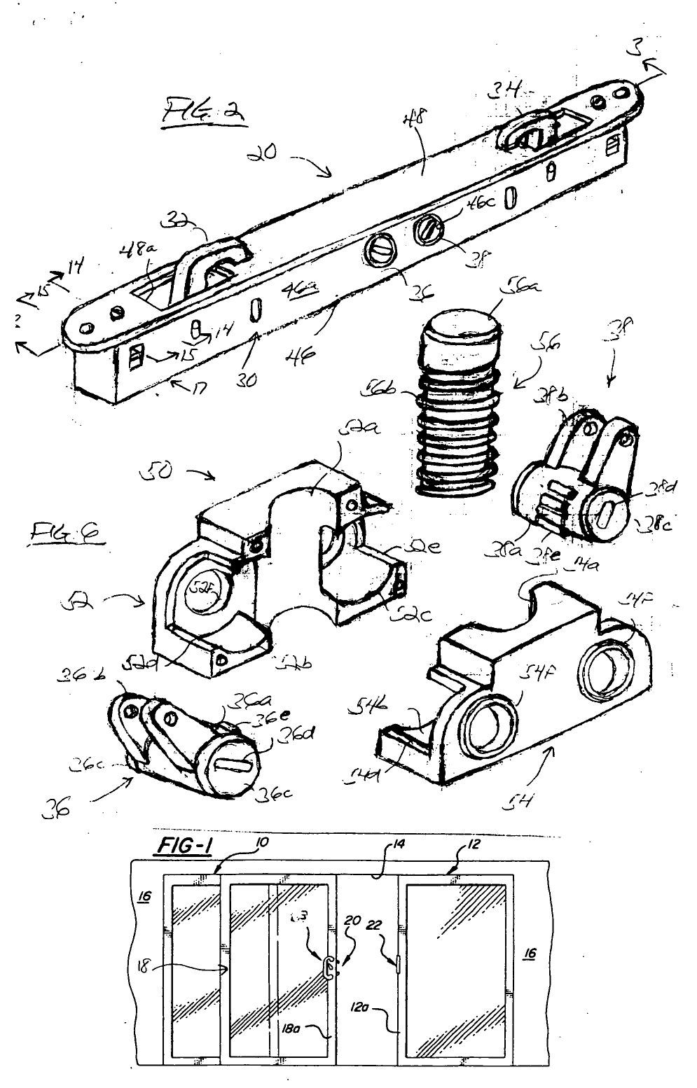

FIG. 1 illustrates a typical sliding patio door installation in which fixed left and right doors 10 and 12 are positioned at the left and right ends of an opening 14 and a building wall 16 and a sliding door 18 is arranged to move between the open position seen in FIG. 1 to a closed position in which the stile 18a of the sliding door is positioned against a jamb 12a defined by the fixed door 12 so that a latch 20 carried by stile 18a may coact with a keeper plate structure 22 positioned on the jamb 12a to maintain the sliding door in a closed position.

As seen in FIG. 2, the invention multi-point sliding door latch 20 is adapted to be fitted into a mortise opening 18b in the lock face 18c of the stile 18a of the sliding door and is arranged for coaction with keeper structure 22 positioned on the associated jamb 12a and for coaction with a handle assembly 23 including an escutcheon plate 24 mounted on the inside face of the stile 18a of the sliding door, a handle 25 mounted on the escutcheon plate, and a thumb turn 26 mounted centrally on the escutcheon plate and including a tail member 27 operated by the thumb turn. It will be understood that the door handle assembly 23 seen in the figures is an inside door handle assembly and that the sliding door 18 further includes an outside door handle assembly (not shown) including an escutcheon plate mounted on the outside face of the stile 18a, a handle mounted on the escutcheon plate, and a key lock mounted centrally on the escutcheon plate operated by a key and controlling a tail member.

Latch 20, broadly considered, includes (FIGS. 3, 4 and 5) a housing assembly 30, upper and lower hooks 32 and 34 mounted in the housing for movement between a retracted unlatched position within the housing and an extended latched position extending out of the housing for engagement with keeper structure 22, upper and lower rotary actuators 36, 38 mounted in the housing in vertically spaced side by side relation between the upper and lower hooks, upper link mechanism 40 interconnecting the upper actuator 36 and the upper hook 32 and operative in response to rotary movement of the upper actuator to move the upper hook from an unlatched to a latched position, and a lower link mechanism 42 interconnecting the lower actuator 38 and the lower hook 34 and operative in response to rotary movement of the lower actuator to move the lower hook from an unlatched position to a latched position.

Housing assembly 34 includes a unitary hollow rectilinear housing 46 and a trim plate 48 forming a lid or cap for the hollow housing 46 and suitably secured thereto to form a rigid housing assembly.

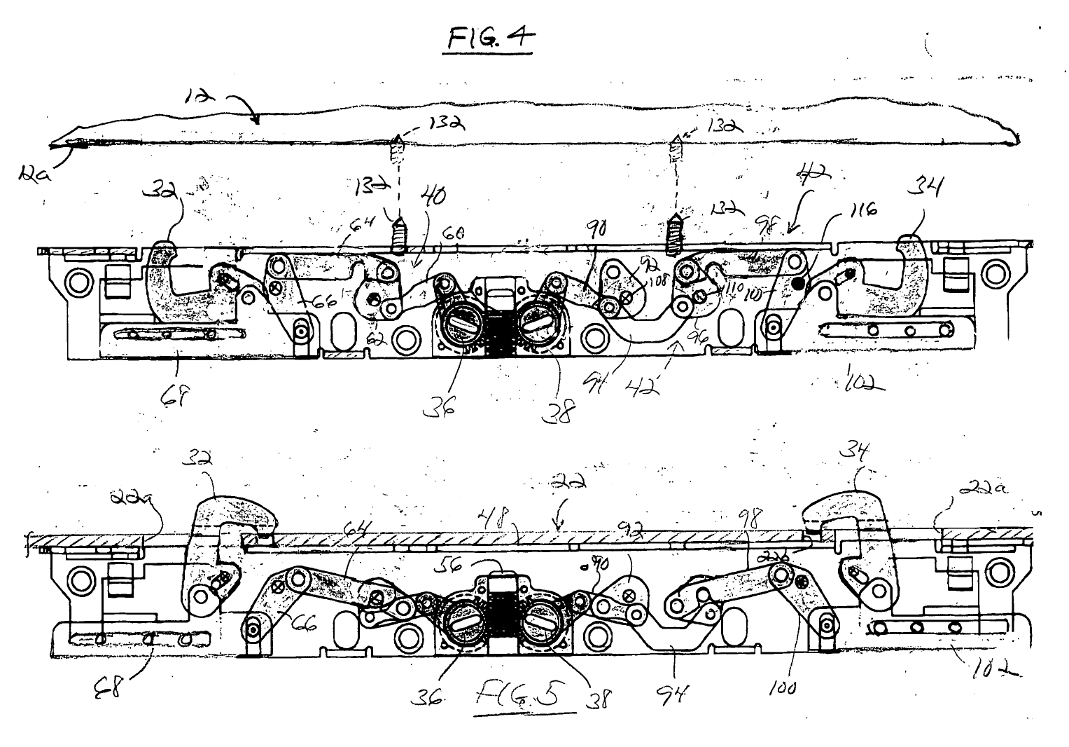

Actuators 36 and 38 form a part of an actuator assembly 50 seen in exploded form in FIG. 6, in elevational form as FIGS. 7 and 8, and in cross-sectional form in FIG. 9. Actuator assembly 50, in addition to actuators 36 and 38, includes a pair of actuator housing halves 52, 54 and a cylindrical rack member 56. Housing halves 52, 54 snap together and are fixedly positioned within the sidewalls 46a, 46b of housing 46. The snapped together housing halves define a vertical bore 52a, 54a mounting the cylindrical rack member 56 for rotary movement about its central axis and further define bores 52b, 54b rotatably mounting the main body cylindrical portion 36a of upper actuator 36 and bores 52c, 54c rotatably mounting the main body cylindrical portion 38a of lower actuator 38. Actuator 36 further includes spaced radial arms 36b extending outwardly from main body cylindrical portion 36a and actuator 38 further includes spaced radial arms 38b extending outwardly from the main body cylindrical portion 38a. Housing halves 52, 54 are selectively cut away at 52d, 54d to pass and accommodate movement of arms 36b in response to rotary movement of actuator 36 and are further cut away at 52e, 54e to pass and accommodate rotary movement of arms 38b in response to rotary movement of actuator 38.

Housings 52, 54 further include flange portions 52f, 54f and these flange portions are suitably piloted into circular apertures 46c in the respective sidewalls 46a, 46b, of the housing 46.

Actuator 36 includes end pilot portions 36c rotatably mounted in flanges 52f, 54f and actuator 38 includes end pilot portions 38c rotatably mounted in flanges 52f, 54f A slot 36d sized to receive tail piece 27 (or the corresponding tail piece from the key lock) extends centrally through the main body portion 36a of actuator 36 and a slot 38d sized to receive tail piece 27 (or the corresponding tail piece of the key lock) extends centrally through the main body portion 38a of actuator 38. The cylindrical main body portion 36a of actuator 36 is provided with a plurality of external pinion teeth 36e and the cylindrical main body portion 38a of actuator 38 is provided with a plurality of external pinion teeth 38e.

Cylindrical rack member 56 includes an upper cap end 56a and a plurality of axially spaced circumferential ribs 56b. These circumferential ribs will be seen to define gear teeth on opposite parallel faces of the cylindrical rack member for meshing engagement, respectively, with the teeth 36e of upper actuator 36 and the teeth 38e of lower actuator 38.

In the assembled relation of the actuator assembly, and with the actuator assembly positioned within the side walls 46a and 46b of the housing 34, cylindrical rack member 56 is mounted for rotation within housing halves 52, 54 for rotary movement about its central axis; pinion teeth 38e of actuator 38 meshingly engage gear teeth defined along one face of cylindrical rack member 56; pinion gear teeth 36e of actuator 38 meshingly engage gear teeth defied by the circumferential ribs 56b along an opposite parallel face of the cylindrical rack member; upper actuator 36 is rotationally mounted in housings 52, 54 via end pilot portions 36c journaled in housing flange portions 52f/54f; lower actuator 36 is rotatably mounted in housings 52, 54 via end pilot portions 38c journaling in housing flange portions 52f/54f, arm portions 36b of actuator 36 extend out of the housing through the cut outs 52d and are allowed to move angularly within the cut outs in response to rotation of actuator 36; and radial arms 38b of actuator 38 extend out of the housing through cut outs 52e and are allowed to move angularly within the cut outs in response to rotation of actuator 38.

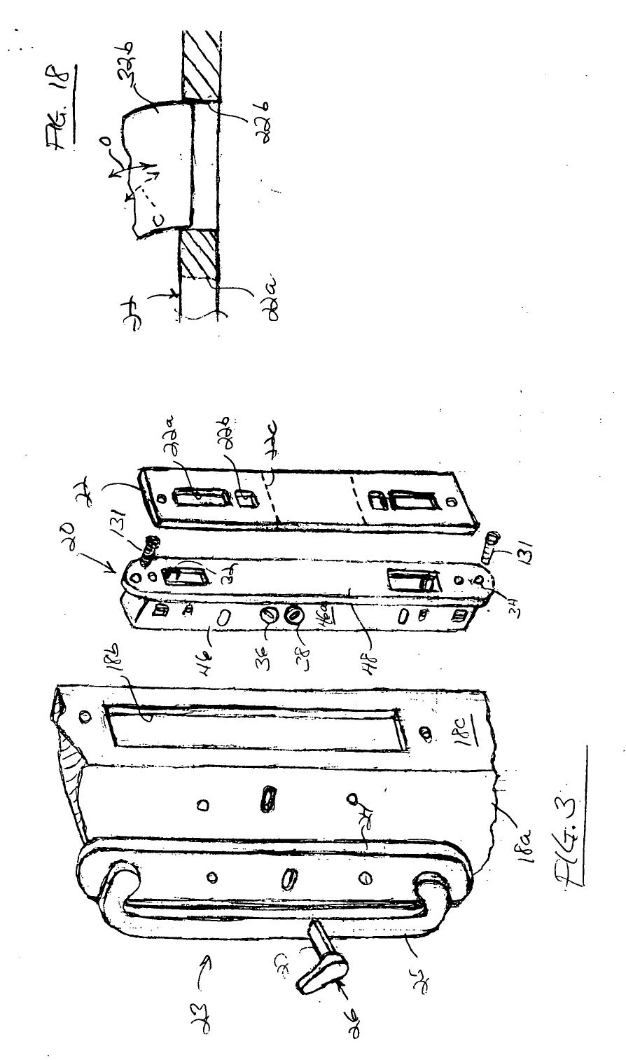

Upper link mechanism 40 (FIGS. 4, 5 and 10) includes a lever 60, a bell crank 62, a lever 64, a lever 66, and a slider 68.

Lever 60 includes a first end 60a journaled by a pivot pin 70 between the radial arms 38b of actuator 38 and a second bifurcated end 60b connected by a pivot pin 72 to a corner of bell crank 62.

Bell crank 62 is pivotally mounted on a post 74 fixedly secured to the latch housing.

Lever 64 is a double lever comprising spaced plate members and is pivotally connected at a first end 64a to another corner of bell crank 62 via a pivot pin 76 and is pivotally connected at a second end 64b to a first end 66a of lever 66 via a pivot pin 78.

Lever 66 is pivotally mounted intermediate in its ends on a post 80 fixedly secured to the latch housing and carries a pin 66b on its second end 66c.

Slider 68 comprises a pair of spaced slider plates each including an elongated axially extending slot 68a and a further lateral slot 68b receiving pin 66b. The spaced slider plates are mounted for sliding movement on a plurality of guide pins 82 which extend fixedly between bracket plates 84 positioned within the latch housing proximate the housing side walls 46a/46b respectively. Each of the slider plates further includes a lug portion 68c mounting a pivot pin 86 pivotally mounting one end 32a of hook 32. Hook 32 further defines a free end latching portion 32b and a slot 32c slidably receiving a post 88 fixedly secured to the latch housing. Slot 32c extends generally in alignment with a line joining the center of post 88 and the center of pin 86.

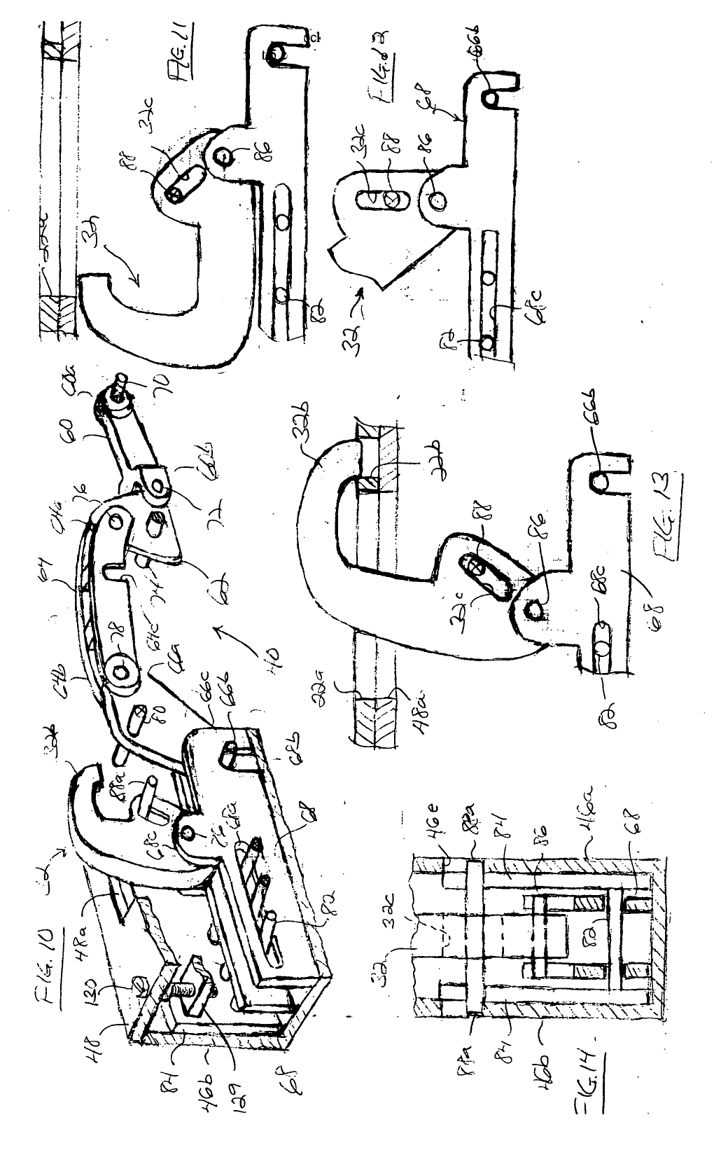

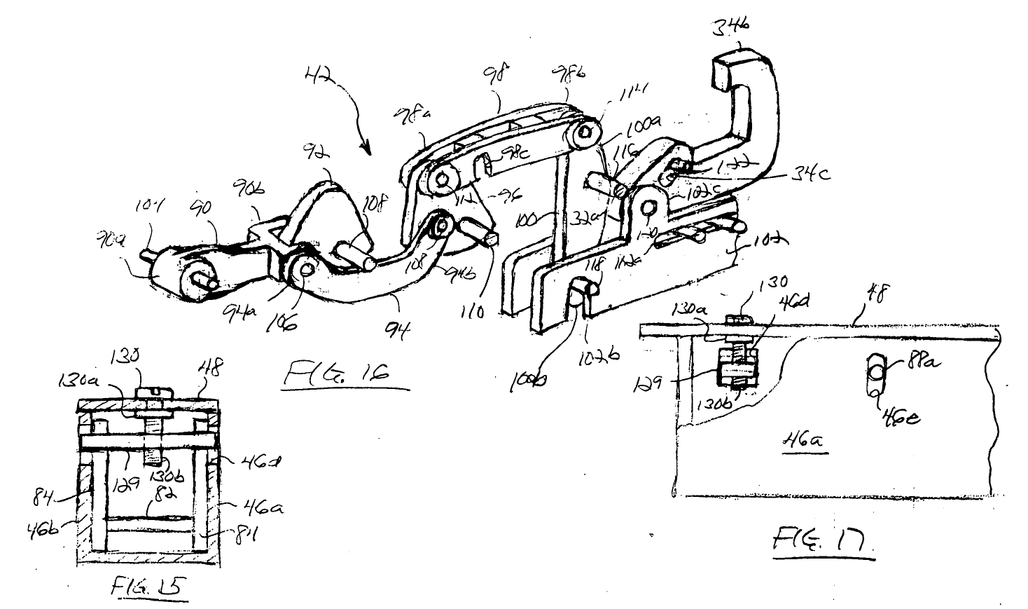

As seen in FIGS. 4, 5 and 10, counterclockwise rotation of actuator 36 in response to rotary movement of thumb turn 26 or the key lock results in leftward movement of the lever 60 which in turn results in clockwise movement of bell crank 62 which in turn results in rightward movement of lever 64 which in turn results in clockwise movement of lever 66 which in turn results in leftward sliding movement of slider 68 which in turn results in clockwise movement of latch 30 from the unlatched position seen in FIG. 4 to the latched position seen in FIG. 5. As the slider 68 moves leftward, guiding on pins 82, hook 32 moves in a translatory manner relative to post 88 and also rotates about post 88. Specifically, as seen in sequential FIGS. 11, 12 and 13, post 88 is positioned proximate the upper end of slot 32c with the hook in the unlatched position of FIG. 11, is positioned proximate the bottom end of slot 32c with the hook in the intermediate position of FIG. 12, and is positioned proximate the upper end of slot 32c with the hook in the latched position of FIG. 13. As the linkage moves from the unlatched position seen in FIG. 4 to the latched position seen in FIG. 5, notches 64c provided in the spaced plates of lever 64 receive the fixed post 74 so that any attempt to apply an unauthorized unlatching force to the hook 32 generates a force urging the link 64 against the fixed post 74 whereby to preclude unauthorized unlatching movement of the hook.

Lower link mechanism 42 (FIGS. 4, 5 and 15) includes a lever 90, a bell crank 92, a lever 94, a bell crank 96, a lever 98, a lever 100, and a slider 102.

Lever 90 includes a first end 90a pivotally mounted between the arms 38b of actuator 38 via a pivot pin 104 and a second bifurcated end 90b pivotally connected to a corner of the bell crank 92 via a pivot pin 106.

Bell crank 92 is pivotally mounted on a post 108 fixedly secured to the latch housing.

Lever 94 includes a first end 94a pivotally connected to bell crank 92 and end 90b of lever 90 via a pivot pin 106 and a second end 94b pivotally connected to a corner of bell crank 96 via a pivot pin 108.

Bell crank 96 is pivotally mounted on a post 110 fixedly secured to the latch housing.

Lever 98 is a compound lever comprising a pair of spaced plates and is pivotally connected at a first end 98a to another corner of bell crank 96 via a pivot pin 112 and is pivotally connected at a second end 98b to a first end 100a of lever 100 via a pivot pin 114.

Lever 100 is pivotally mounted on a post 116 fixedly secured to the latch housing and carries a pin 118 on its second end 100b.

Slider 102 comprises a pair of spaced slider plates corresponding to the slider plates 68 of the upper link mechanism 40. The slider plates 102 guide on guide pins 82 fixedly secured to plates 84 positioned within the sidewalls 46a/46b of the latch housing via elongated axially extending slots 102a. Each slider plate 102 further defines a lateral slot 102b slidably receiving pin 118.

Hook 34 includes a first end 34a pivotally mounted on lug portions 102c of the slider plates via a pivot pin 120 and further defines a latch end 34b. Hook 34b further defines an elongated slot 34c coacting with a post 122 fixedly secured to the latch housing and extending in general alignment with a line joining the centers of post 122 and pin 120.

With reference to FIGS. 4, 5 and 15, as actuator 38 is rotated in a clockwise direction via either the thumb turn or the key lock, lever 90 is moved to the right as viewed in FIG. 4 which results in counterclockwise pivotal movement of bell crank 92 about post 108 which results in rightward movement of link 94 which results in counterclockwise pivotal movement of bell crank 96 about post 110 which results in leftward movement of link 98 which results in counterclockwise pivotal movement of link 100 about post 116 which results in rightward sliding movement of the slider plates guiding on pins 82. As described with respect to the link mechanism 40, the rightward sliding movement of the slider plates moves hook 34 in a translatory and rotational manner relative to post 122 from the unlatched position seen in Figure 4 to the latched position seen in FIG. 5. Also as described with respect to the link mechanism 40, as the link 98 moves from its unlatched position of FIG. 4 to the latched position of FIG. 5, notches 98c in the spaced plate members comprising lever 98 move over post 110 so that any attempt to pry the latch open via force applied at the hook 34 is defeated by the engagement of the post 110 in the notches 98c.

Note that the link mechanism 42, while generally similar to link mechanism 40, includes an extra link 94 and an extra bell crank 96 to accommodate the fact that the actuators 36/38 are not centered along the length of the latch housing but rather are closer to the hook 32 than the hook 34.

Note further that the geometry of the link mechanisms 40 and 42 is such that in each case rotational movement of the respective actuator results in rotational movement of the respective hook that is at least twice as great as the rotational movement of the respective actuator.

The invention latch also includes an anti-slam feature best seen in FIGS. 7 and 8. The anti-slam device comprises a lever 126 pivotally mounted within latch housing 46 via a post 128 fixedly secured to the housing. Lever 126 includes an arcuate block arm or finger 26a adapted for blocking coaction with the enlarged end 90a of lever 90 and an actuator arm 126b projecting through an opening 48a in the trim plate 48. A leaf spring 128 fixedly secured to lever 126 is biased against the inner face 48b of trim plate 48 and is operative to maintain the anti-slam device in the blocking position seen in FIG. 7 in which the block arm 126a wraps around the enlarged end 90a of lever 90 to preclude movement of the lever from the unlatched position seen in FIGS. 4 and 7 to the latched position seen in FIGS. 5 and 8. A stop bar 127, rigid with the housing, limits the inward or blocking movement of the finger 126a to avoid interference with the operation of link mechanism 42.

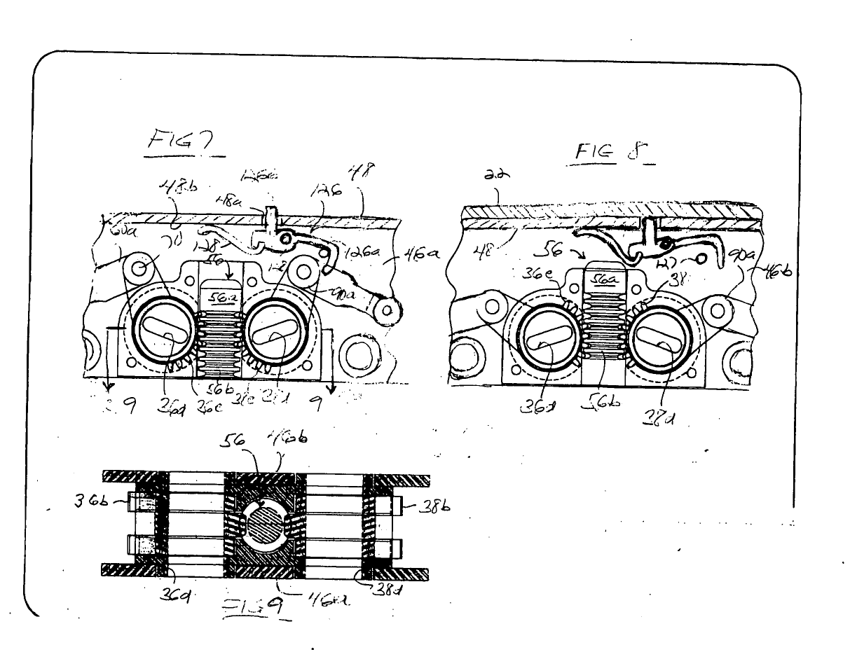

The invention latch also includes means to adjust the starting or rest position of the hooks. Specifically, with reference to hook 32 and FIGS. 10, 14, 15 and 17, a rectangular cross-section bar 129 extends fixedly through bracket plates 84 with its opposite ends 129a received in oversized rectangular openings 46d in housing side walls 46a, 46b; a screw 130 is journaled in trim plate 48 and includes a collar 130a and a lower threaded portion 130b threadably engaging bar 129; and the outer ends 88a of post 88 extend outwardly through bracket plates 84 for receipt in elongated slots 46e in housing sidewalls 46a and 46b. A similar arrangement provides adjustment for hook 34. It will be seen that selective rotation of screws 130 selectively moves bars 129; within rectangular openings 46d and selectively moves post ends 88a in slots 46e to selectively adjust the starting or rest positions of the hooks.

### Installation and Operation

The assembled latch is installed in the mortise opening 18b in lock face 18c of the stile 18a of the sliding door in known manner utilizing fasteners 131 passing through apertures in the trim plate 48 for engagement with suitable threaded apertures in the lock face 18c. In the installed position of the latch, slots in the escutcheon plate and in the side face of the stile allow passage of the tail piece 27 of the thumb screw (or the tail piece of the key lock) to engage one or the other of the slots 36d/38d in the actuators whereby turning movement of the thumb turn or the key lock rotates the engaged actuator which, by virtue of the cylindrical rack member 56, simultaneously rotates the other actuator in an opposite direction whereby to simultaneously, via the link mechanisms 40 and 42, move the hooks 32 and 34 from the unlatched position to the latched position. The mounting of the rack member 56 for rotary movement about a central axis enables the rack member to adjust rotationally in response to the application of force from either actuator to assume a position in which the stress loading in the system as between the upper and lower actuators is essentially equalized whereby to neutralize asymmetrical loading in the latch.

As the engaged actuator is rotated in a latching direction the hooks 32/34 move outwardly through trim plate openings 48a and keeper openings 22a in a combined translatory and rotational manner to their latched positions in which hook ends 32b/34b are received in keeper plate openings 22b. It will be understood that the movement of the hooks from unlatched to latched positions constitutes a generally elliptical or oval movement, as distinguished from a purely circular movement. As best seen by the arrow 0 in FIG. 18, the elliptical or oval movement of the hooks allows the hook end portions 32b/34b to move more positively into the keeper openings 22b as opposed to the circular hook movement illustrated by the arrow C. The oval movement of the hooks also assures a more positive retracting movement of the hook end portions 32b/34b out of the keeper openings 22b whereby to insure that the hooks may enter the keeper openings in a firm positive manner and yet not “hang up” in the keeper openings when an attempt is made to move the hooks to their unlatched positions.

As the hooks move from their unlatched to their latched positions, the fixed posts 74/110 move into the respective slots 64c/98c whereby to preclude unauthorized prying opening movement of the hooks from their latched to their unlatched positions. Note in this regard that the geometry of the link mechanisms is such that this anti-theft feature does not interfere with the movement of the hooks from their latched to their unlatched positions in response to rotation of a respective actuator so that authorized opening of the latches is not interfered with.

Prior to installation of the keeper plate, as the sliding door with the latch installed is initially moved to a closed position relative to the jamb 12a, a pair of pointed screws 132 threadably secured to the trim plate of the latch housing impact upon the face of jamb 12a and serve to indentingly mark the jamb. Since the relationship of the screws 132 to the hooks 32/34 is precisely known, the marks created by the screw points may be utilized to precisely adjust the keeper structure relative to the hooks after which the pointed screws 132 may be removed. Specifically, the keeper structure is adjusted on the jamb such that score marks 22c on the keeper structure are aligned with the screw point indentations on the jamb, whereby to insure precise alignment and coaction as between the keeper plate openings and the hooks.

With the latch installed in the door stiles and with the hooks in their unlatched position the device 126 serves as an anti-slam feature and specifically precludes inadvertent movement of the hooks from their unlatched to their latched positions. As the door is thereafter closed the actuator arm 126b of the device 126 engages the keeper plate and the lock arm 126a is rotated out of engagement with the link 90 so that deliberate movement of the hooks from their unlatched to latched position may now be performed.

The latch of the invention will be seen to provide many important advantages.

Specifically, the ability of the cylindrical rack member of the actuator assembly to rotationally adjust to accommodate uneven stress loading caused by engagement of one or the other of the actuators precludes binding of the actuator assembly and insures smooth positive operation of the actuator assembly irrespective of which actuator is engaged and irrespective of asymmetrical conditions within the actuator assembly and/or within the total door handle assembly environment.

Further, the combined translatory and thereafter rotational movement of the latches from their unlatched to their latched positions assures a firm positive latching action and assures that the hooks will not become “hung up” in the keeper structure.

Further, the engagement of the posts 74/110 with the notches 64c, 98c provides an effective anti-theft feature precluding inadvertent prying open of the hooks.

Further, the anti-slam lever 126 precludes inadvertent movement of the hooks to their latched position.

Further, the fact that the last, most outboard element in each link mechanism 40/42 comprises a linearly sliding member simplifies the provision of further hook members, outboard of members 32/34, if further hook members are desired to add even further security to the latch. Specifically, a further sliding element carrying a further hook may readily be coupled to each sliding member 68/102 to readily provide further hooks and thereby further security.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A multi-point sliding door latch including a housing, a pair of vertically spaced upper and lower hooks mounted in the housing for movement between a retracted, unlatched position within the housing and an extended, latched position extending out of the housing for engagement with a keeper structure of an associated jamb, upper and lower rotary actuators mounted in the housing in vertically spaced side by side relation between the upper and lower hooks, an upper link mechanism interconnecting the upper actuator and the upper hook and operative in response to rotary movement of the upper actuator to move the upper link from an unlatched to a latched position, and a lower link mechanism interconnecting the lower actuator and the lower hook and operative in response to rotary movement of the lower actuator to move the lower hook from an unlatched position to a latched position, characterized in that:
the latch further includes a rack positioned between the actuators and defining gear teeth on opposite parallel faces thereof;
each actuator includes pinion gear teeth; and
the pinion gear teeth of the upper actuator meshingly engage the gear teeth on one face of the rack and the pinion gear teeth on the lower actuator meshingly engage the gear teeth on the opposite face of the rack.

2. A latch according to claim 1 wherein the rack comprises a cylindrical member having a series of circumferential ribs defining the gear teeth.

3. A latch according to claim 2 wherein the cylindrical rack member is mounted in the housing for rotary movement about its central axis.

4. A latch according to claim 1 wherein at least one of said link mechanisms comprises a mechanism that is operative in response to a turning force applied at the respective actuator to move the respective hook from its latched to its unlatched position, but is operative in response to a force applied at the hook to block movement of the hook from its latched to its unlatched position.

5. A latch according to claim 4 wherein both of said link mechanism comprise a link mechanism that is operative in response to a turning movement applied at the respective actuator to move the respective hook from its latched to its unlatched position, but is operative in response to a force applied at the hook to block movement of the hook from its latched to its unlatched position.

6. A latch according to claim 4 wherein:
said one linkage mechanism includes at least one link and a post fixed to the housing;
said one link includes a slot that receives the fixed post in response to movement of the respective hook from its unlatched to its latched position; and
force applied to the hook in the latched position thereof generates a force urging the one link against the fixed post.

7. A latch according to claim 6 wherein the fixed post comprises a pivot pin in the linkage mechanism.

8. A latch according to claim 1 wherein the latch further includes a lock mechanism normally operative to preclude movement of the hooks from the unlatched to the latched position but operative in response to engagement thereof with the keeper structure of the associated jamb to allow such movement.

9. A latch according to claim 8 wherein:
the lock mechanism comprises a lever pivotally mounted on the housing and including a first actuator end and a second lock end;
the lock mechanism further includes a spring normally maintaining the lever in a position in which the actuator end projects out of the housing and the lock end blocks movement of the hooks from their unlatched to their latched positions; and
the lever rotates against the bias of the spring in response to engagement of the actuator end with the keeper structure of the associated jamb upon closing of the door against the jamb to rotate the lock end to a position allowing movement of the hooks from their unlatched to their latched positions.

10. A latch according to claim 1 wherein each hook undergoes a combined translatory and rotational movement in its movement from an unlatched to a latched position.

11. A latch according to claim 10 wherein each linkage mechanism comprises a plurality of pivotally interconnected links extending between the respective actuators and the respective hook

12. A latch according to claim 11 wherein the interconnected links of each linkage mechanism are operative to generate rotational movement of the respective hook that is at least twice as great as the rotational movement of the respective actuator.

13. A latch according to claim 12 wherein both of said link mechanisms comprise a link mechanism that is operative in response to a turning movement applied at the respective actuator to move the respective hooks from its latched to its unlatched position but is operative in response to a force applied at the hook to block movement of the hook from its latched to its unlatched position.

14. A multi-point sliding door latch including a housing, a pair of vertically spaced upper and lower hooks mounted in the housing for movement between a retracted, unlatched position within the housing and an extended, latched position extending out of the housing for engagement with a keeper structure of an associated jamb, upper and lower rotary actuators mounted in the housing in vertically spaced side by side relation between the upper and lower hooks, an upper link mechanism interconnecting the upper actuator and the upper hook and operative in response to rotary movement of the upper actuator to move the upper link from an unlatched to a latched position, and a lower link mechanism interconnecting the lower actuator and the lower hook and operative in response to rotary movement of the lower actuator to move the lower hook from an unlatched position to a latched position, characterized in that:
at least one of said link mechanisms is operative in response to a turning force applied at the respective actuator to move the respective hook from its latched to its unlatched position but is operative in response to a force applied at the hook to block movement of the hook from its latched to its unlatched position.

15. A latch according to claim 14 wherein:
said one linkage mechanism includes at least one link and a post fixed to the housing;
said one link includes a slot that receives the fixed post in response to movement of the respective hook from its unlatched to its latched position; and
force applied to the hook in the latched position thereof generates a force urging the one link against the fixed post.

16. The latch according to claim 15 wherein the fixed post comprises a pivot pin in the linkage mechanism.

17. A latch according to claim 14 wherein:
the latch lever includes a rack positioned between the actuator and defining gear teeth on opposite parallel faces thereof;
each actuator includes pinion gear teeth; and
the pinion gear teeth of the upper actuator meshingly engage the gear teeth on one face of the rack and the pinion gear teeth on the lower actuator meshingly engage the gear teeth on the opposite face of the rack.

18. A latch according to claim 17 wherein the rack comprises a cylindrical member having a series of circumferential ribs defining the gear teeth.

19. A latch according to claim 18 wherein the cylindrical rack member is mounted in the housing for rotary movement about its central axis.

20. A multi-point sliding door latch including an elongated housing, a pair of vertically spaced upper and lower hooks mounted in the housing for movement between a retracted, unlatched position within the housing and an extended, latched position extending out of the housing for engagement with a keeper structure of an associated jamb, upper and lower rotary actuators mounted in the housing in vertically spaced side by side relation between the upper and lower hooks, an upper link mechanism interconnecting the upper actuator and the upper hook and operative in response to rotary movement of the upper actuator to move the upper link from an unlatched to a latched position, and a lower link mechanism interconnecting the lower actuator and the lower hook and operative in response to rotary movement of the lower actuator to move the lower hook from an unlatched position to a latched position, characterized in that:
each hook undergoes a combined translatory and a rotational movement and it moves from an unlatched to a latched position.

21. A latch according to claim 20 wherein each linkage mechanism includes a pivotal link and a slider mounted for linear sliding movement in a direction generally parallel to the longitudinal extent of the housing.

22. A latch according to claim 21 wherein:
each hook includes a free unlatching portion and an end remote from the latching portion;
each hook is pivotally mounted at its remote end by a pivot pin to the slider of the respective link mechanism.

23. A latch according to claim 22 wherein:
each hook includes a slot between the free end latching portion and the remote end; and
the latch further includes a post rigid with the housing received in the slot of each hook.

24. A latch according to claim 23 wherein the slot of each hook extends in general alignment with a line joining the center of the respective post and the center of the respective pivot pin.

25. A method of installing a keeper structure for a sliding door latch assembly of the type including a latch for installation on a leading edge of the sliding door and a keeper structure for installation on a jamb against which the sliding door closes, the method comprising:
installing the latch on the leading edge of the sliding door;
installing at least one marker member on a leading edge of the latch projecting forwardly from the leading edge of the latch;
sliding the door toward the jamb to cause the marker member to engage the jamb and form a mark on the jamb;
mounting the keeper structure on the jamb in a position relative to the mark such that the latch properly coacts with the keeper structure to latch the door against the jamb; and
removing the marker member from the latch.

26. A method according to claim 25 wherein:
the marker member comprises a pointed screw threaded into a trim plate at the leading edge of the latch; and
the mark comprises an indentation in the jamb.

27. A method according to claim 26 wherein the latch is a multipoint latch including two hook members and there are two pointed screws installed on the trim plate to respectively locate the two hooks.

28. A method according to claim 26 wherein the keeper structure comprises a plate including openings to receive the hooks and a score mark for alignment with the indentation mark on the jamb.
